(19) United States
(12) Patent Application Publication
(10) Pub. No.: US 2024/0303981 A1
(43) Pub. Date: Sep. 12, 2024

(54) IMAGE PROCESSING DEVICE, IMAGE PROCESSING METHOD, AND PROGRAM

(71) Applicant: SONY GROUP CORPORATION, TOKYO (JP)

(72) Inventors: HIROMITSU HATAZAWA, TOKYO (JP); YUSUKE SASAKI, TOKYO (JP); YUKI MURATA, TOKYO (JP); HIROYUKI ICHIKAWA, TOKYO (JP)

(21) Appl. No.: 18/261,341

(22) PCT Filed: Dec. 17, 2021
(86) PCT No.: PCT/JP2021/046765

§ 371 Date: Jul. 13, 2023

(30) Foreign Application Priority Data
Jan. 22, 2021 (JP) 2021-008713

(51) Int. Cl. G06V 10/94; G06T 3/40; G06V 10/764; H04N 5/262; H04N 23/80

(52) U.S. Cl. CPC G06V 10/945; G06T 3/40; G06V 10/764; G06V 10/955; H04N 5/2628; H04N 23/80

(57) ABSTRACT

An image processing device includes an image processing unit that specifies a target pixel area including a target subject from an image to be processed and performs image processing using the specified target pixel area.

### TECHNICAL FIELD

The present technique relates to an image processing device, an image processing method, and a program and relates to an image processing technique for displaying a captured image.

### BACKGROUND ART

PTL 1 describes a digital camera that enables correct confirmation of a focusing position from a captured image that is reproduced after shooting. PTL 1 describes that a storage area for image data is allocated to a memory area for the storage unit of the digital camera and data related to image data can be stored in the image data storage area. PTL 1 discloses that the storage area includes an area for storing image data about a captured image and an additional information area for storing focusing position data that determines a focusing position called a tag on an image during shooting.

### CITATION LIST

### Patent Literature

### [PTL 1]

JP 2001-128044A

### SUMMARY

### Technical Problem

In a use case called tethered shooting, an imaging device (camera) and a personal computer (PC) or the like are connected to each other, an image is captured by the camera, the captured image is reproduced and displayed on the PC in real time or after shooting, and the contents of the image are confirmed.

For example, in commercial shooting, a photographer photographs commercial products and persons (models) in a studio and sequentially displays captured images on a PC, and the images are checked by the photographer, a stylist, a sponsor, and a client or the like.

In such a case, shooting is performed while many images are confirmed. A captured image, in particular, has various points to be noticed. For example, in shooting of a model, points to be noticed according to an image are a facial expression of the model, a state of makeup, a costume, a hairstyle, and a pose. In the case of commercial shooting, points to be noticed include whether a product is free of contamination, scratches, or reflection and whether the lighting and layout of the product is correct.

Furthermore, points to be noticed during image confirmation vary among persons in charge. For example, in shooting of a model holding a product, a stylist pays attention to the costume and the hairstyle and a staff member from the vendor of the product pays attention to the state of imaging of the product held by the model.

In such a case, difficulty in sufficient confirmation by each staff member cannot be eliminated only by displaying captured images on a PC.

For example, when multiple images are sequentially captured and displayed, PC operations including enlargement of a specific point on each image may result in an extremely long confirmation time. Moreover, points to be noticed vary among staff members and thus may lead to complicated confirmation.

The present technique provides an image processing device that facilitates confirmation of a subject to be noticed in a plurality of images.

### Solution to Problem

An image processing device according to the present technique includes an image processing unit that specifies a target pixel area including a target subject from an image to be processed and performs image processing using the specified target pixel area.

The target subject is a common subject set to be noticed in a plurality of images. The target subject indicates, for example, a person, human parts such as a face and a hand, a specific person, a specific type of article, or a specific article.

For example, if a target subject is specified in advance or can be specified under some conditions including a focusing position, a target pixel range of the target subject is specified in an image to be processed, and then processing such as enlargement and synthesis is performed.

In the image processing device according to the present technique, the image processing unit determines a target subject set on a first image, the target subject being determined by image analysis on a second image to be processed, and the image processing unit performs image processing on the second image by using a target pixel area specified on the basis of the determination of the target subject. After a target subject is set in a certain image (first image), other images (second image) are set to be processed. At this point, in the second image, a target subject is determined by image analysis and a target pixel area is specified.

In the image processing device according to the present technique, the image analysis may be object recognition.

For example, the presence or absence of a target subject and the position of the target subject in an image (pixel area) are determined by an object recognition algorithm of semantic segmentation or the like.

In the image processing device according to the present technique, the image analysis may be personal identification.

For example, a person serving as a subject is personally identified, and a specific person is set as a target subject. The presence or absence of the specific person and a pixel area are determined in the second image.

In the image processing device according to the present technique, the image analysis may be posture estimation.

For example, the posture of a person serving as a subject is estimated, and the pixel area of a target subject is determined according to the posture.

In the image processing device according to the present technique, the image analysis may be enlargement of a target pixel area.

In other words, when a target pixel area is specified as the area of a target subject, processing is performed to enlarge the target pixel area.

In the image processing device according to the present technique, the image processing is synthesis of an image of a target pixel area onto other images.

In other words, when a target pixel area is specified as the area of a target subject, processing is performed to synthesize the target pixel area onto other images.

In the image processing device according to the present technique, the second image indicates a plurality of images inputted to be processed after the first image.

After a target subject is set in the first image, for example, if captured images are inputted by sequential shooting or images are sequentially inputted by frame advance of reproduced images, the sequentially inputted images are subjected to image analysis as second images.

In the image processing device according to the present technique may further include a setting unit that sets a target subject on the basis of a specification input on the first image.

A target subject is set when a user specifies the target subject in the first image.

In the image processing device according to the present technique, the specification input may be allowed to be a voice specification input.

For example, the type of a subject is recognized when the subject in the first image is specified by a user's voice, and the then subject is set as a target subject.

In the image processing device according to the present technique, the image processing unit may perform image processing using a target pixel area specified on the basis of a focusing position in an image to be processed.

The focusing position is determined, and then the target pixel area is specified with respect to the focusing position.

In the image processing device according to the present technique, the image processing may be enlargement of an image of a target pixel area on the basis of a focusing position.

When the target pixel area is specified on the basis of the focusing position, processing is performed to enlarge the target pixel area.

In the image processing device according to the present technique, the image processing unit may perform image processing using a target pixel area specified on the basis of the result of object recognition of a subject according to a focusing position in an image to be processed.

In other words, the focusing position is determined, the subject at the focusing position is recognized, and the range of the subject is set as a target pixel area.

In the image processing device according to the present technique, the image processing may be enlargement of an image of a target pixel area on the basis of object recognition of a subject according to a focusing position.

When the target pixel area is specified on the basis of the focusing position and the result of object recognition, processing is performed to enlarge the target pixel area.

In the image processing device according to the present technique, the image processing unit may determine a change of a target subject or a change of a scene by image analysis and changes the contents of image processing according to the determination of the change.

For example, in the process of sequentially inputting images, when the pose or costume of a target subject is changed, a person is changed, or a change of a scene is detected by a change of a person or a background, the contents of image processing are changed.

In the image processing device according to the present technique may further include a display control unit that performs control to display an image having been subjected to image processing by the image processing unit and an overall image including a target pixel area to be subjected to image processing.

For example, an image subjected to image processing including enlargement and synthesis and an overall image before the processing are displayed in one screen.

In the image processing device according to the present technique, in the overall image, display may be provided to indicate a target pixel area to be subjected to image processing.

In other words, in the overall image, a target pixel area subjected to enlargement or synthesis or the like is presented to the user by, for example, frame display.

An image processing method according to the present technique includes causing an image processing device to specify a target pixel area including a target subject from an image to be processed and perform image processing using the specified target pixel area and perform image processing using the specified target pixel area. Thus, a target pixel area is specified for each pixel.

A program according to the present technique is a program that causes an information processing device to perform the image processing. Thus, the image processing device can be easily implemented.

### BRIEF DESCRIPTION OF DRAWINGS

FIG. 1 is an explanatory drawing of a device connection configuration according to an embodiment of the present technique.

FIG. 2 is a block diagram of an imaging device according to the embodiment.

FIG. 3 is a block diagram illustrating an information processing device according to the embodiment.

FIG. 4 is an explanatory drawing of the function of the image processing device according to the embodiment.

FIG. 5 is an explanatory drawing of a display example in which a face is to be noticed in a first embodiment.

FIG. 6 is an explanatory drawing of a display example in which an article is to be noticed in the first embodiment.

FIG. 7 is an explanatory drawing of a display example in which an article is to be noticed in the first embodiment.

FIG. 8 is an explanatory drawing of a display example in which a specific person is to be noticed in the first embodiment.

FIG. 9 is an explanatory drawing of a display example in which a specific part of a person is to be noticed in the first embodiment.

FIG. 10 is an explanatory drawing of a display example according a second embodiment.

FIG. 11 is an explanatory drawing of a display example according a third embodiment.

FIG. 12 is an explanatory drawing of a display example according a fourth embodiment.

FIG. 13 is an explanatory drawing of a display example applicable to the embodiments.

FIG. 14 is an explanatory drawing of a display example applicable to the embodiments.

FIG. 15 is a flowchart showing a processing example of image display according to the embodiments.

FIG. 16 is a flowchart of setting according to the embodiments.

FIG. 17 is a flowchart of subject enlargement according to the embodiments.

FIG. 18 is a flowchart of synthesis according to the embodiments.

FIG. 19 is a flowchart of the enlargement of a focusing position according to the embodiments.

### DESCRIPTION OF EMBODIMENTS

Hereinafter, embodiments will be described in the following order.
<1. Device Configuration>
<2. First Embodiment>
<3. Second Embodiment>
<4. Third Embodiment>
<5. Fourth Embodiment>
<6. Display examples applicable to embodiments>
<7. Processing example for display in embodiments>
<8. Conclusion and modification example>

### 1. Device Configuration

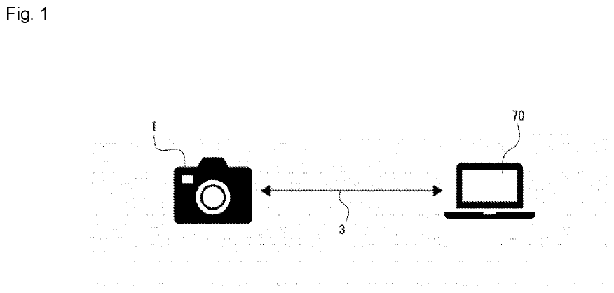

FIG. 1 illustrates a configuration example of a system according to embodiments. The system includes an imaging device 1 and an information processing device 70 that can communicate with each other via a transmission line 3.

The imaging device 1 is assumed to be, for example, a camera used for tethered shooting by a photographer in a studio or the like. The specific type, model, specifications or the like of the imaging device 1 are not limited. In the description of the embodiments, the imaging device 1 is assumed to be a camera capable of shooting of still images. A camera capable of video shooting may be used instead.

The information processing device 70 acts as an image processing device of the present disclosure.

The information processing device 70 is assumed to be a device capable of displaying images transferred from the imaging device 1 or reproduced images or a device capable of causing a connected display device to display images.

The information processing device 70 is, for example, a computer device capable of information processing, particularly image processing. Specifically, the information processing device 70 is assumed to be a personal computer (PC), a portable terminal device, e.g., a smartphone or a tablet, a mobile phone, video editing equipment, or a video reproducer.

It is also assumed that the information processing device 70 can conduct various kinds of analysis using machine learning with an AI (artificial intelligence) engine. For example, in image analysis as AI processing for inputted images, an AI engine can perform processing including image contents determination, scene determination, object recognition (including face recognition and character recognition), personal identification, and posture estimation.

The transmission line 3 may be a wired-connection transmission line with a video cable, a USB (Universal Serial Bus) cable, and a LAN (Local Area Network) cable or the like or a wireless transmission line using Bluetooth (registered trademark) and Wi-Fi (registered trademark) communications. Alternatively, the transmission line 3 may be a transmission line connecting remote locations via Ethernet, a satellite communication line, or a telephone line. For example, a captured image may be confirmed at a location remote from a photo studio.

An image captured by the imaging device 1 via the transmission line 3 is inputted to the information processing device 70.

Alternatively, a captured image may be recorded in a portable recording medium, e.g., a memory card in the imaging device 1, and then the memory card may be provided to the information processing device 70 to deliver the image. The recording medium is not illustrated.

The information processing device 70 can display a captured image in real time while the image is transmitted from the imaging device 1 during shooting, and can reproduce and display a captured image after temporarily storing the image in a storage medium.

An image may be transferred in a file format, e.g., JPEG (Joint Photographic Experts Group) from the imaging device 1 to the information processing device 70 or may be transferred as binary information such as RGB data, which is not a file. The data format is not particularly limited.

For example, the system constructed as illustrated in FIG. 1 allows the information processing device 70 to display a captured image that is obtained in shooting by a photographer using the imaging device 1, enabling various staff members to confirm the image.

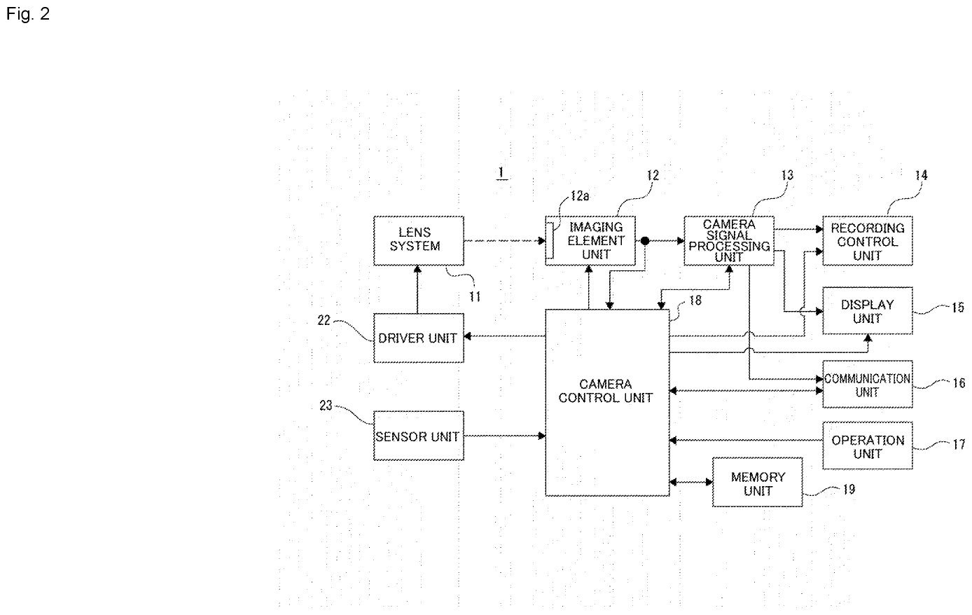

Referring to FIG. 2, a configuration example of the imaging device 1 will be described below.

The imaging device 1 includes, for example, a lens system 11, an imaging element unit 12, a camera signal processing unit 13, a recording control unit 14, a display unit 15, a communication unit 16, an operation unit 17, a camera control unit 18, a memory unit 19, a driver unit 22, and a sensor unit 23.

The lens system 11 includes lenses such as a zoom lens and a focus lens and an aperture mechanism. The lens system 11 guides light (incident light) from a subject to condense the light on the imaging element unit 12.

The imaging element unit 12 includes, for example, a CMOS (Complementary Metal Oxide Semiconductor) or CCD (Charge Coupled Device) type image sensor 12a (imaging element).

The imaging element unit 12 executes, for example, CDS (Correlated Double Sampling) or AGC (Automatic Gain Control) processing on an electric signal obtained by photoelectric conversion of light received by the image sensor 12a, and further performs A/D (Analog/Digital) conversion. Thereafter, an imaging signal as digital data is outputted to the camera signal processing unit 13 or the camera control unit 18 at a subsequent stage.

The camera signal processing unit 13 is configured as an image processing processor by, for example, a DSP (Digital Signal Processor). The camera signal processing unit 13 performs various kinds of signal processing on a digital signal (captured image signal) from the imaging element unit 12. For example, the camera signal processing unit 13 performs preprocessing, synchronization, YC generation, resolution conversion, and file formation as a camera process.

In the preprocessing, for example, clamping for clamping black levels of R, G, and B to predetermined levels and correction among color channels of R, G, and B are performed on the captured image signal from the imaging element unit 12.

In the synchronization, color separation is performed to allow image data of pixels to have all color components of R, G, and B. For example, in the case of an imaging element in which color filters in a Bayer layout are used, demosaic processing is performed as color separation.

In the YC generation, a luminance (Y) signal and a color (C) signal are generated (separated) from the image data of R, G, and B.

In the resolution conversion, resolution conversion is performed on image data having been subjected to various kinds of signal processing.

In the file formation, a file for recording or communications is generated by performing, for example, compression coding for recording or communication, formatting, and the generation or addition of metadata for, for example, image data having been subjected to the various kinds of processing.

For example, an image file in formats such as JPEG, TIFF (Tagged Image File Format), and GIF (Graphics Interchange Format) is generated as a still image file. Alternatively, an image file may be generated in an MP4 format or the like that is used for recording moving images and sounds in conformity with MPEG-4. Moreover, an image file may be generated as RAW image data.

The camera signal processing unit 13 generates metadata as information including information about processing parameters in the camera signal processing unit 13, various control parameters acquired from the camera control unit 18, information indicating the operating states of the lens system 11 and the imaging element unit 12, mode setting information, imaging environment information (including a date and time and a location), information about a focus mode, information about focusing positions in captured images (e.g., coordinate values in images), information about zoom factors, identification information about the imaging device, and information about mounted lenses.

The recording control unit 14 performs recording and reproduction in a recording medium configured as, for example, a nonvolatile memory. The recording control unit 14 performs, for example, processing for recording an image file of moving-image data and still-image data and metadata including thumbnail images and screen nail images in a recording medium.

The recording control unit 14 may be configured in various actual forms. For example, the recording control unit 14 may be configured as a flash memory and a writing/reading circuit in the imaging device 1. Alternatively, the recording control unit 14 may be configured as a card recording and reproducing unit that makes record and reproduction access to a recording medium, for example, a memory card (a portable flash memory or the like) that is detachably mounted in the imaging device 1. In some cases, the recording control unit 14 is implemented as, for example, an HDD (Hard Disk Drive) installed in the imaging device 1.

The display unit 15 is a display unit that provides various types of display for an imaging person. The display unit 15 is a display panel or a viewfinder that includes a display device, for example, a liquid crystal panel (LCD: Liquid Crystal Display) or an organic EL (Electro-Luminescence) display disposed in the housing of the imaging device 1.

The display unit 15 provides various kinds of display on a display screen on the basis of an instruction from the camera control unit 18.

For example, the display unit 15 displays a reproduced image of image data read from the recording medium in the recording control unit 14.

The display unit 15 receives image data on a captured image subjected to the resolution conversion for display by the camera signal processing unit 13. In some cases, the display unit 15 provides display on the basis of the image data on the captured image in response to an instruction from the camera control unit 18. This displays a so-called through image (monitoring image of a subject) that is an image captured during the confirmation of the composition or the recording of a moving image.

The display unit 15 provides display of various operation menus, icons, and messages or the like, that is, a GUI (Graphical User Interface) on the screen on the basis of an instruction from the camera control unit 18.

The communication unit 16 performs wired or radio data communications or network communications with an external device. For example, captured image data (still image file or moving image file) or metadata is transmitted and outputted to an external information processing device, an external display device, an external recording device, and an external reproduction device.

The communication unit 16 as a network communication unit performs communications via, for example, various networks such as the Internet, a home network, and a LAN (Local Area Network) to transmit and receive various kinds of data to and from a server and a terminal or the like on the networks.

The imaging device 1 may be capable of information communications with, for example, a PC, a smartphone, and a tablet or the like through, for example, near field radio communications of Bluetooth, Wi-Fi communications, and NFC or the like and infrared communications by means of the communication unit 16. Moreover, the imaging device 1 may communicate with another device through wired connection communications.

Thus, the communication unit 16 can transmit captured images and metadata to the information processing device 70 through the transmission line 3 in FIG. 1.

The operation unit 17 collectively indicates input devices for allowing a user to perform various manipulated inputs. Specifically, the operation unit 17 indicates various kinds of operators (including keys, a dial, a touch panel, and a touch pad) provided on the housing of the imaging device 1.

The operation unit 17 detects a user operation and a signal corresponding to an inputted operation is transmitted to the camera control unit 18.

The camera control unit 18 configured with a microcomputer (arithmetic processing device) including a CPU (Central Processing Unit).

The memory unit 19 stores information or the like for processing by the camera control unit 18. The illustrated memory unit 19 generically indicates, for example, a ROM (Read-Only Memory), a RAM (Random Access Memory), and a flash memory. The memory unit 19 may be a memory area embedded in a microcomputer chip serving as the camera control unit 18 or may be configured with a separate memory chip.

The camera control unit 18 controls the overall imaging device 1 by executing a program stored in the ROM or the flash memory or the like of the memory unit 19. For example, the camera control unit 18 controls an operation of each necessary unit regarding the control of a shutter speed of the imaging element unit 12, instructions of various kinds of signal processing in the camera signal processing unit 13, an imaging operation or a recording operation in response to a user operation, a reproducing operation of a recorded image file, operations of the lens system 11, e.g., zooming, focusing, diaphragm adjustment in a lens barrel, and a user interface operation.

The RAM in the memory unit 19 is used to temporarily store data and programs or the like, as a work area during various types of data processing of the CPU of the camera control unit 18.

The ROM or the flash memory (nonvolatile memory) of the memory unit 19 is used to store application programs for various operations, firmware, and various kinds of setting information or the like in addition to an OS (Operating System) used for the CPU to control each unit and content files such as an image file.

The various kinds of setting information include communication setting information, an exposure setting as setting information about an imaging operation, a shutter speed setting, a mode setting, a white balance setting as setting information related to image processing, a color setting, a setting for an image effect, a custom key setting as setting information related to operability, and a display setting.

The driver unit 22 is provided with, for example, a motor driver for a zoom lens drive motor, a motor driver for a focus lens drive motor, and a motor driver for an aperture mechanism motor.

These motor drivers apply a drive current to the corresponding driver in response to an instruction from the camera control unit 18 and cause the driver to move a focus lens or a zoom lens and open and close the aperture blades of the aperture mechanism.

The sensor unit 23 generically indicates various sensors mounted in the imaging device.

The sensor unit 23 is, for example, an IMU (Inertial Measurement Unit) and can detect, for example, an angular velocity using an angular velocity (gyro) sensor for three axes of pitch, yaw, and roll, and detect an acceleration using an acceleration sensor.

As the sensor unit 23, for example, a positional information sensor, an illuminance sensor, or a range sensor or the like may be mounted.

Various kinds of information detected by the sensor unit 23, for example, position information, distance information, illuminance information, and IMU data or the like are added as metadata to a captured image along with date time information managed by the camera control unit 18.

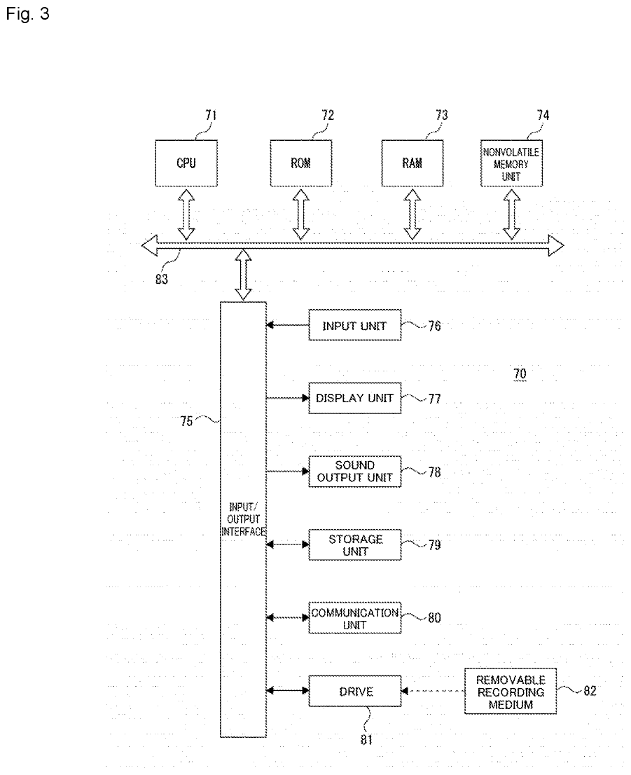

Referring to FIG. 3, a configuration example of the information processing device 70 will be described below.

A CPU 71 of the information processing device 70 performs various kinds of processing according to a program stored in a ROM 72 or a nonvolatile memory unit 74, e.g., an EEP-ROM (Electrically Erasable Programmable Read-Only Memory) or a program loaded from a storage unit 79 to a RAM 73. In the RAM 73, data necessary for the CPU 71 to perform various kinds of processing is also stored as appropriate.

The CPU 71, the ROM 72, the RAM 73, and the nonvolatile memory unit 74 are connected to one another via a bus 83. An input/output interface 75 is also connected to the bus 83.

Since the information processing device 70 of the present embodiment is provided to perform image processing and AI processing, a GPU (Graphics Processing Unit), a GPGPU (General-purpose computing on graphics processing units), and an AI-specific processor or the like may be provided instead of or along with the CPU 71.

An input unit 76 including an operator or an operation device is connected to the input/output interface 75. For example, the input unit 76 is assumed to be various operators or operation devices such as a keyboard, a mouse, keys, a dial, a touch panel, a touch pad, and a remote controller.

A user operation is detected by the input unit 76, and a signal corresponding to the input operation is interpreted by the CPU 71.

The input unit 76 is also assumed to be a microphone. A user's voice may be inputted as operation information.

Furthermore, a display unit 77 including an LCD or an organic EL panel or the like and a sound output unit 78 including a speaker or the like are connected as a single unit or separate units to the input/output interface 75.

The display unit 77 is a display unit that provides various kinds of display, and is configured with, for example, a display device provided in the housing of the information processing device 70 or a separate display device connected to the information processing device 70.

The display unit 77 displays images for various kinds of image processing and moving images to be processed, on the display screen in response to an instruction from the CPU 71. The display unit 77 also provides display as a GUI (Graphical User Interface), for example, various operation menus, icons, and messages in response to an instruction from the CPU 71.

In some cases, the storage unit 79 including a hard disk and a solid-state memory or a communication unit 80 including a modem are connected to the input/output interface 75.

The communication unit 80 performs communication processing via transmission paths such as the Internet and communications using wired/wireless communications or bus communications with various kinds of devices.

Communications with the imaging device 1, particularly the reception of a captured image or the like is performed by the communication unit 80.

A drive 81 is also connected to the input/output interface 75 as necessary, and a removable recording medium 82, e.g., a magnetic disk, an optical disc, a magneto-optical disc, or a semiconductor memory is loaded in the drive 81 as appropriate.

The drive 81 enables reading of data files such as an image file and various computer programs or the like from the removable recording medium 82. The read data file is stored in the storage unit 79 or an image or a sound included in the data file is outputted by the display unit 77 or the sound output unit 78. A computer program or the like read from the removable recording medium 82 is installed onto the storage unit 79 as necessary.

In the information processing device 70, for example, software for processing in the present embodiment can be installed through network communications using the communication unit 80 or via the removable recording medium 82. Alternatively, the software may be stored in advance in the ROM 72 or the storage unit 79 or the like.

For example, if the information processing device 70 acts as an information processing device for performing processing on an inputted image, software for image display processing for a target subject is installed, the processing including setting, enlargement, and synthesis, which will be described later. In this case, the CPU 71 (may be an AI-specific processor or a GPU or the like) acts to perform necessary processing.

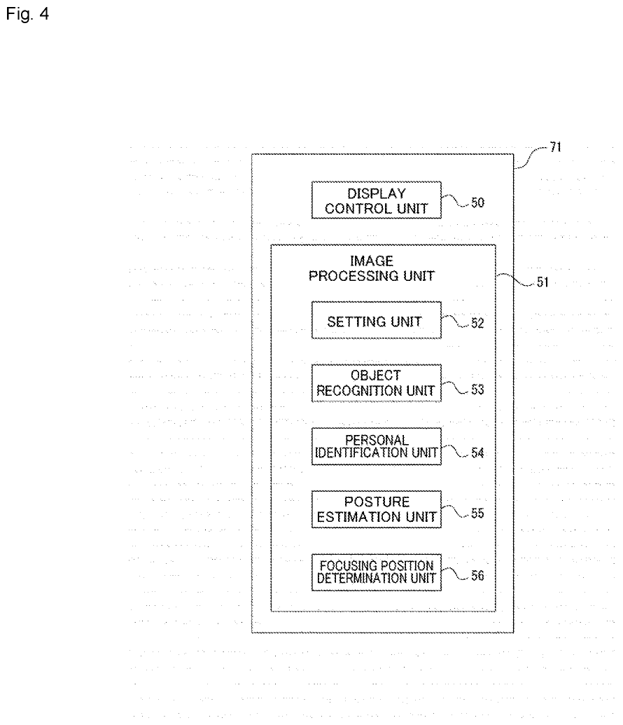

FIG. 4 is a block diagram of functions performed by the CPU 71.

For example, the installation of software for image processing provides a display control unit 50 and an image processing unit 51 for the CPU 71 as illustrated in FIG. 4.

The image processing unit 51 has functions including a setting unit 52, an object recognition unit 53, a personal identification unit 54, a posture estimation unit 55, and a focusing position determination unit 56 along with the image processing function.

These functions are not all necessary for the processing of embodiments described later. Some of the functions may be omitted.

The display control unit 50 has the function of controlling image display on the display unit 77. Particularly in the present embodiment, for example, when an image is transferred from the imaging device 1 or when an image stored in the storage unit 79 is reproduced after the transfer, the display is provided.

In this case, the display control unit 50 performs control to display an image processed by the image processing unit 51 (enlarged image or synthesized image), in a display format defined by software serving as an application program for confirming the image.

Moreover, in this case, the display control unit 50 performs control to display an image having been subjected to image processing such as enlargement and synthesis by the image processing unit 51 and an overall image (originally captured image) including a target pixel area to be subjected to the image processing.

The image processing unit 51 is the function of specifying a target pixel area including a target subject from an image to be processed and performing image processing using the specified target pixel area. The image processing is, for example, enlargement and synthesis (also including scaling associated with synthesis).

In order to perform such image processing using a target pixel area in the image processing unit 51, the setting unit 52, the object recognition unit 53, the personal identification unit 54, the posture estimation unit 55, and the focusing position determination unit 56 act to specify the target pixel area.

The setting unit 52 is the function of setting a target subject. For example, the setting unit 52 sets a target subject in response to a user operation or recognizes a user's voice to set a target subject by automatic determination.

The object recognition unit 53 is the function of recognizing an object serving as a subject in an image, the object being recognized by, for example, an object recognition algorithm of semantic segmentation or the like.

The personal identification unit 54 is the function of identifying a specific person among subject persons by using an algorithm for identifying a subject person with reference to a database that manages the characteristics of each person.

The posture estimation unit 55 is the function of determining the position of each part (e.g., the head, body, hand, or foot) of a person in an image by using a posture estimation algorithm of a subject person.

The focusing position determination unit 56 is the function of determining a focusing position in an image (a pixel area where focus is obtained). The focusing position may be determined on the basis of metadata or the focusing position may be determined by performing image analysis, for example, processing such as edge determination in an image.

### 2. First Embodiment

An embodiment of image display provided in the information processing device 70 configured thus will be described below.

As the first embodiment, an example will be described that a target subject is set in an image such that a pixel area (target pixel area) where the target subject is present also in the subsequent images is enlarged and displayed.

“Target subject” in the embodiment means a common subject set to be noticed in a plurality of images. The target subject indicates a subject recognizable by image analysis, for example, a person, human parts such as a face and a hand, a specific person, a specific type of article, or a specific article. From among these subjects, a subject to be noticed (to be checked in an image) is set as a target subject.

“Target pixel area” is a range of pixels including a target subject in an original image. In an image, in particular, a target pixel area is a pixel area extracted to be subjected to image processing including enlargement and synthesis.

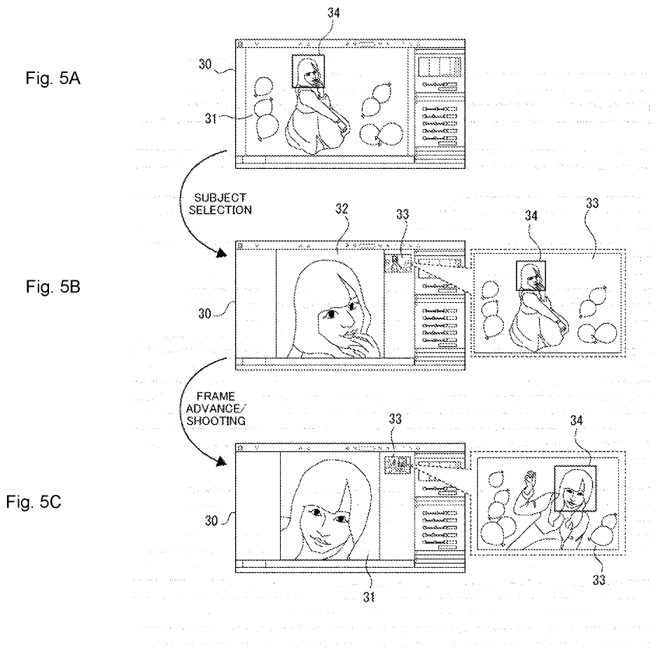

FIGS. 5A, 5B, and 5C illustrate a confirmation screen 30 that is displayed on the display unit 77 by the CPU 71 operating on the basis of an application program for implementing the functions of FIG. 3. The confirmation screen 30 is a screen that displays images sequentially inputted to the information processing device 70 by shooting of a photographer, allowing a staff member to confirm the contents of the images.

For example, captured still images may be displayed one by one on the confirmation screen, or a plurality of images stored in the storage unit 79 or the removable recording medium 82 after being captured may be sequentially reproduced and displayed.

In the confirmation screen 30 of FIG. 5A, an original image 31 is displayed as it is. The original image 31 is a captured image that is transferred from the imaging device 1 or a reproduced image that is read from the storage unit 79 or the like. FIG. 5A illustrates a target subject before a setting is made.

A user performs an operation for specifying a subject to be enlarged or a pixel area in the original image 31 by, for example, a drag-and-drop operation using a mouse or a touching operation.

In the illustrated example, a user-specified range is indicated as an enlargement frame 34 and the target subject is, for example, “face” of a model.

The CPU 71 sets, as a target pixel area, an area specified by a user operation, that is, an area specified by the enlargement frame 34, recognizes a subject in the pixel area by object recognition, and sets the subject as a target subject. In this case, the “face” of a person is set as the target subject.

When a user touches a point in an image by a touching operation, the CPU 71 may recognize a subject at the point by object recognition, set the subject as a target subject, and set the range of the subject as a target pixel area. For example, the user specifies the face part of a model with a touch on the screen, so that “face” is set as a target subject.

Alternatively, a target subject may be specified by a user's voice. For example, when the user utters “face,” the CPU 71 can recognize “face” through analysis of the voice of the user by the function of the setting unit 52 and set “face” as a target subject. In this case, the area of “face” is determined by object recognition on the original image 31, so that an area where the face is located in the image, that is, a target pixel area can be determined and the enlargement frame 34 can be displayed as illustrated.

Alternatively, a target subject may be specified by inputting characters such as “face” instead of a user's voice or a target subject may be specified by user-selected icons of faces, hairstyles, hands, feet, and articles that are prepared as a user interface in the confirmation screen 30.

Furthermore, in a form of a specifying operation according to a subject type recognized by analyzing the original image 31, faces and articles or the like may be displayed as target subject candidates selectable by a user.

An interface for setting such target subjects is preferably implemented by the CPU 71 as the function of the setting unit 52 of FIG. 3.

After a target subject is set in the foregoing example, the CPU 71 enlarges a target pixel area and displays an enlarged image 32 as illustrated in FIG. 5B. The CPU 71 also displays the overall original image 31 as an overall image 33 along with the enlarged image 32.

In this example, the enlarged image 32 is large and the overall image 33 is small. The size ratio of the enlarged image 32 and the overall image 33 is not limited to that of the illustrated example. The overall image 33 may be set larger. The size ratio of the enlarged image 32 and the overall image 33 may be changed in response to a user operation.

However, a user intends to confirm a target subject specified by a mouse operation or a voice or the like. Thus, at least in an initial state of display, it is preferable to largely display the enlarged image 32 of a target subject (strictly a target pixel area) in the confirmation screen 30.

For the overall image 33 displayed in a relatively small size, the enlargement frame 34 is displayed as enlarged on the right side of FIG. 5B. Thus, the user can easily recognize which part of the overall image 33 is displayed as the enlarged image 32.

It is assumed that an image to be processed for display is switched. For example, it is assumed that another image is inputted to the information processing device 70 through shooting by a photographer or frame advance is made for a reproduced image. In this case, the image of the confirmation screen 30 is displayed as illustrated in FIG. 5C.

In the case of FIG. 5C, the enlarged image 32 of “face” as a target subject and the overall image 33 are initially displayed without the need for a user-specified range of enlargement.

Specifically, when a subsequent image is displayed in a state where a target subject has been already set, the CPU 71 retrieves a target subject by image analysis on the subsequent image and sets, as a target pixel area, an image area including the target subject. The target pixel area is then enlarged. Thus, as illustrated in FIG. 5C, the overall image 33 and the enlarged image 32 are initially displayed.

For the overall image 33, the enlargement frame 34 is displayed as enlarged on the right side of FIG. 5C such that the target subject (and the target pixel area) is recognizable. Thus, the setting of the target subject can be transferred to an image where a target subject has not been specified, and the user can easily recognize the range of an enlarged target pixel area in the overall image 33.

Also when a subsequent image to be processed for display is changed by shooting or frame advance, which is not illustrated, the enlarged image 32 and the overall image 33 are initially displayed as in the example of FIG. 5C.

Thus, only by initially specifying a target subject (or target pixel area), the user can continuously view an enlarged image of a part to be particularly confirmed over a plurality of images.

Since a target pixel area is set as a range including a target subject in each image, the target pixel area does not always have the same size. For example, as is evident from a comparison between the overall images 33 in FIGS. 5B and 5C, the enlargement frame 34 indicating a target pixel area has different sizes.

In other words, a target pixel area to be enlarged changes with the size of a target subject in each image.

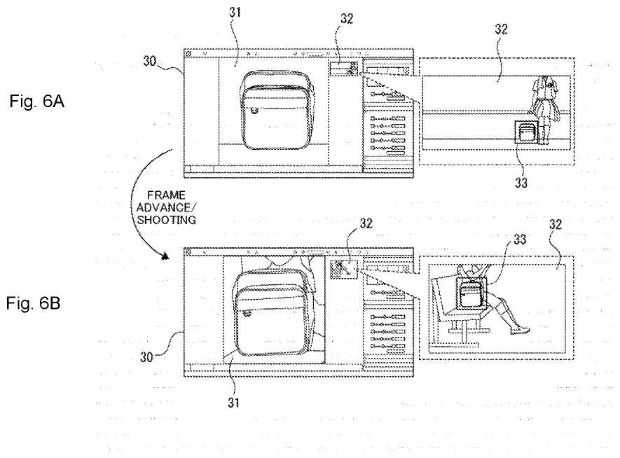

In the foregoing example, “face” is a target subject. It is needless to say that an article may be used instead as a target subject. FIGS. 6A and 6B illustrate an example in which “bag” is identified as a target subject from images having different scenes and brightness levels and is displayed as an enlarged image.

In the example of FIG. 6A, “bag” is set as a target subject. In this state, the enlarged image 32 of a bag and the overall image 33 are displayed on the confirmation screen 30. In the overall image 33, the enlargement frame 34 including the part of the bag is displayed.

Even if an image to be displayed is changed, as illustrated in FIG. 6B, the enlarged image 32 of the bag and the overall image 33 are displayed on the confirmation screen 30.

Specifically, a bag is initially set as a target subject and thus is recognized by, for example, a semantic segmentation algorithm even in subsequent images having different scenes and brightness levels, so that a target pixel area including the bag is determined and is enlarged to display the enlarged image 32.

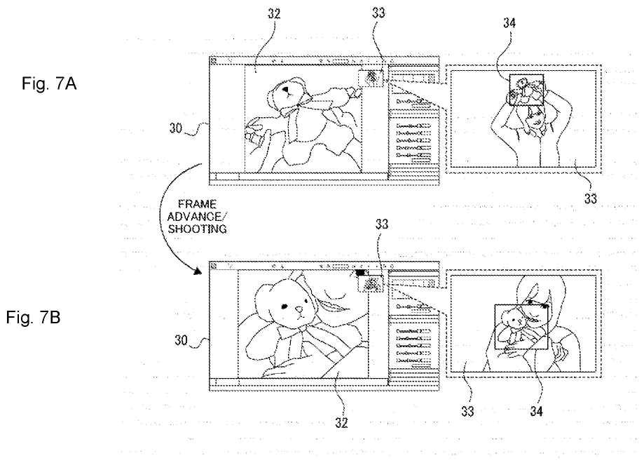

FIGS. 7A and 7B illustrate an example in which a part of an object of a target subject is displayed in an image. Also in this case, the part is enlarged if the part can be determined by object recognition.

In the example of FIG. 7A, “stuffed toy” is set as a target subject. In this state, the enlarged image 32 of a stuffed toy and the overall image 33 are displayed on the confirmation screen 30. In the overall image 33, the enlargement frame 34 including the part of the stuffed toy is displayed.

Even if an image to be displayed is changed, as illustrated in FIG. 7B, the enlarged image 32 of the stuffed toy and the overall image 33 are displayed on the confirmation screen 30.

In FIG. 7B, as shown in the overall image 33, the stuffed toy is recognized by, for example, a semantic segmentation algorithm in an image where the legs of the stuffed toy are hidden. When the target subject partially hidden in the image is recognized, a target pixel area including the target subject is determined and enlarged, so that the enlarged image 32 is displayed.

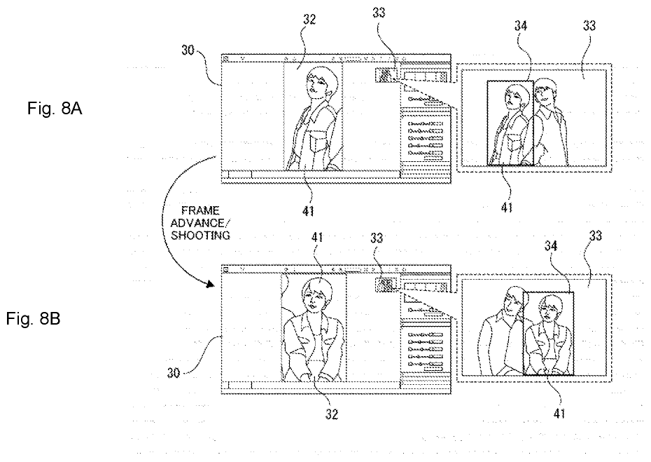

FIGS. 8A and 8B illustrate an example in which a personal identification algorithm is used.

It is assumed that a specific person is set as a target subject.

In the example of FIG. 8A, on the confirmation screen 30, a target pixel area including a specific person 41 as a target subject is enlarged in an image including a plurality of persons, the target pixel area is displayed as the enlarged image 32, and the overall image 33 is displayed. In the overall image 33, the enlargement frame 34 including the part of the specific person 41 is displayed.

Even if an image to be displayed is changed, as illustrated in FIG. 8B, the enlarged image 32 of the specific person 41 and the overall image 33 are displayed on the confirmation screen 30.

Specifically, the specific person 41 is initially set as a target subject and thus a subject as the specific person 41 is determined by character identification in subsequent images, so that a target pixel area including the specific person 41 is specified. The target pixel area is then enlarged to display the enlarged image 32.

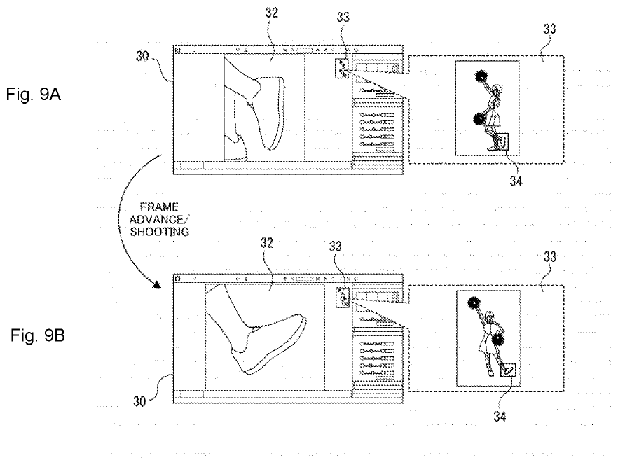

FIGS. 9A and 9B illustrate an example in which a posture estimation algorithm is used.

It is assumed that a part of a person, for example, “foot” is set as a target subject. In the example of FIG. 9A, on the confirmation screen 30, a target pixel area including “foot” as a target subject is enlarged and is displayed as the enlarged image 32, and the overall image 33 is displayed. In the overall image 33, the enlargement frame 34 including the part of the foot is displayed.

Even if an image to be displayed is changed, as illustrated in FIG. 9B, the enlarged image 32 of the part of the foot and the overall image 33 are displayed on the confirmation screen 30.

Specifically, “foot” is initially set as a target subject and thus the posture of the person is estimated in subsequent images to determine the part of the foot from the posture, so that a target pixel area including the part is specified. The target pixel area is then enlarged to display the enlarged image 32.

If a target subject is a part relocated according to the posture of a human body, for example, “shoe,” “glove,” or “hat” as well as human body parts such as “foot,” the target subject may be similarly determined on the basis of posture estimation.

As described above, by setting a target subject in the first embodiment, a target pixel area including the set target subject is automatically specified in subsequently displayed images and is displayed after being enlarged. Thus, without the need for specifying an area to be enlarged in each of a large number of images, a part to be noticed (that is, to be checked) by a user is automatically enlarged, so that each image is confirmed with quite high efficiency.

Even if points to be confirmed vary among staff members, the staff members can confirm the points only by specifying a target subject and displaying the target subject while frame advance of images in the forward direction.

### 3. Second Embodiment

As a second embodiment, an example of synthesis will be described below.

For example, a background image is set and a target subject is also set such that the target subject in sequentially displayed images is displayed to be synthesized with the background image.

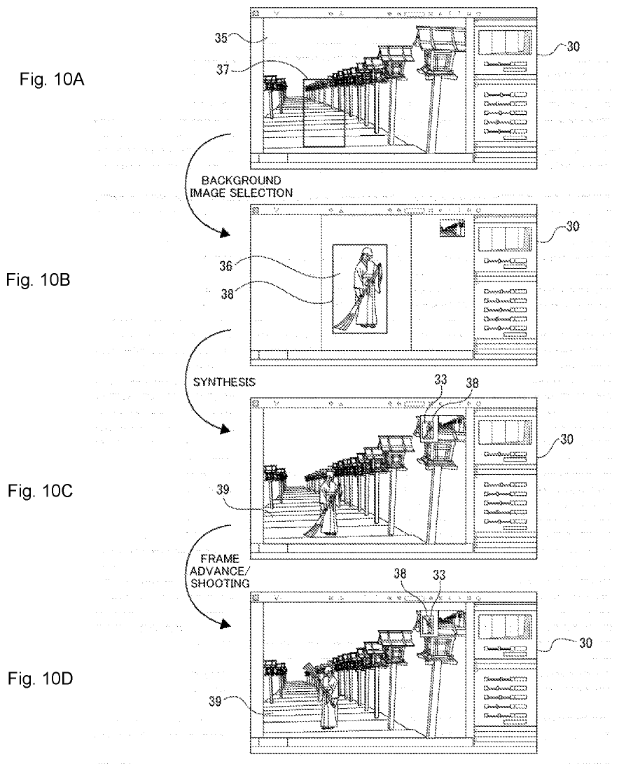

FIG. 10A shows a background image 35 specified by a user.

The user specifies a position where another image is to be superimposed, the position being indicated by a superimposition position frame 37 in the background image 35. It is assumed that a range is specified on a screen by, for example, a mouse operation or a touching operation.

FIG. 10B shows an original image 36 to be processed in response to shooting or reproduction.

The user performs an operation for specifying a target subject in the original image 36. As in the first embodiment, it is assumed that methods for specifying a target subject (or specifying a target pixel area) in the original image 36 include an operation of a mouse or the like, a voice input, selection of icons or the like, and selection from candidates.

Furthermore, as in the first embodiment, a target pixel area is specified according to the specification of a target subject or a target subject is set by specifying a target pixel area through a user operation for specifying a range.

FIG. 10B shows a state in which a person is specified as a target subject, a target pixel area including the target subject is set, and the target pixel area is indicated as a superimposition target frame 38.

After the background image 35, the superimposition position (the range of the superimposition position frame 37), and the target subject are set thus, a CPU 71 performs synthesis in response to the input (reproduction) of a captured image. FIG. 10C shows a state in which the CPU 71 performs synthesis to superimpose the target pixel area on the background image 35 and displays a composite image 39. The CPU 71 also displays an overall original image 36 as an overall image 33.

In this example, the composite image 39 is large and the overall image 33 is small. The size ratio of the composite image 39 and the overall image 33 is not limited to that of the illustrated example. The overall image 33 may be set larger. The size ratio of the composite image 39 and the overall image 33 may be changed in response to a user operation.

However, a user intends to confirm the composite image 39. Thus, at least in an initial state of display, it is preferable to largely display the composite image 39 in a confirmation screen 30.

For the overall image 33 displayed in a relatively small size, the superimposition target frame 38 is displayed. Thus, the user can easily recognize which part of the overall image 33 is synthesized in the background image 35.

It is assumed that an image to be processed for display is switched. For example, it is assumed that another image is inputted to the information processing device 70 through subsequent shooting or frame advance is made for a reproduced image. In this case, the image of the confirmation screen 30 is displayed as illustrated in FIG. 10D.

In the case of FIG. 10D, the composite image 39 including the target subject synthesized in the background image 35 and the overall image 33 are initially displayed without the need for a user-specified target subject or target pixel area.

Specifically, when a subsequent image is displayed in a state where a target subject has been already set, the CPU 71 retrieves a target subject by image analysis on the subsequent image and sets, as a target pixel area, an image area including the target subject. Thereafter, synthesis is performed to superimpose the target pixel area on the superimposition position frame 37 set in the background image 35. Thus, as illustrated in FIG. 10D, the overall image 33 and the composite image 39 are initially displayed.

The size of the target pixel area (that is, the size of the superimposition target frame 38) and the size of the superimposition position frame 37 in the background image 35 are not always equal to each other. Thus, the CPU 71 may perform synthesis after enlarging or reducing the target pixel area according to the size of the superimposition position frame 37.

For the overall image 33, the superimposition target frame 38 is displayed such that the target subject (and the target pixel area) is recognizable. Thus, the setting of the target subject can be transferred to an image where a target subject has not been specified, and the user can easily recognize, in the overall image 33, the range of the target pixel area synthesized in the background image 35.

Also when a subsequent image to be processed for display is changed by shooting or frame advance, which is not illustrated, the composite image 39 including the target subject synthesized in the background image 35 and the overall image 33 are initially displayed as in the example of FIG. 10D.

Thus, only by setting the background image 35 and the superimposition position frame 37 and specifying a target subject (or target pixel area) in the first image to be processed, the user can continuously view an image of the target subject synthesized in the background image 35 over a plurality of images.

This facilitates confirmation of matching between, for example, a pose and a facial expression of a model and the background image during shooting.

In this example, synthesis with the background image 35 was described. This same holds true for synthesis with a foreground image and synthesis of a background image and a foreground image.

### 4. Third Embodiment

As a third embodiment, an example of image processing using a target pixel area will be described below. The target pixel area is specified on the basis of a focusing position in an image to be processed.

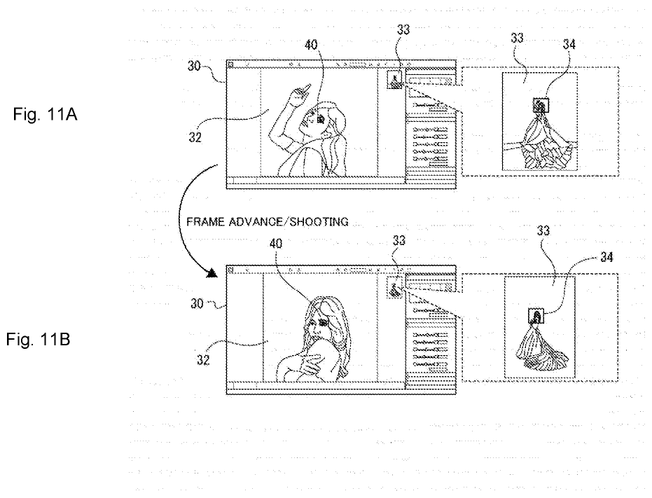

FIG. 11A shows an example in which an enlarged image 32 and an overall image 33 are displayed on a confirmation screen 30.

In this case, the enlarged image 32 is not obtained on the basis of a user-specified target subject but is an enlarged image with a target pixel area specified on the basis of a focusing position in an original image.

It is assumed that the original image to be processed obtains focus at an eye of a model serving as a subject. In the original image, a CPU 71 automatically sets, as a target pixel area, a pixel area of a predetermined range with respect to, for example, the part of an eye at a focusing position in the original image.

The target pixel area is then enlarged to display the pixel area as the enlarged image 32 as illustrated in FIG. 11A.

Moreover, the CPU 71 displays the target pixel area with respect to the eye such that the target pixel area is indicated by an enlargement frame 34 in the overall image 33. Thus, in particular, regarding an image where an operation for specifying a point of enlargement is not performed, the user can easily recognize the range of an enlarged target pixel area in the overall image 33.

The CPU 71 also displays a focus frame 40 in the enlarged image 32. By the display of the focus frame 40, it is easily understood that the enlarged image 32 is an image enlarged with respect to a focus part indicated by the focus frame 40.

FIG. 11B illustrates the case where an image to be processed for display is switched.

Also in this case, the CPU 71 specifies a target pixel area according to a focusing position and enlarges the area. The enlarged image 32 and the overall image 33 are then displayed on the confirmation screen 30.

As described above, according to the third embodiment, the user can view the enlarged image 32, which is an image enlarged with respect to the focusing position, as one of images to be sequentially confirmed on the confirmation screen 30. The focusing position is a point where a photographer obtains focuses as a point to be noticed. Considering the focusing position is the most significant point to be checked, it is also effective to provide such display during image confirmation.

The illustrated focus frame 40 obtains focus at the eye. It is needless to say that the focus frame 40 at a face or the focus frame 40 at another article may be displayed.

### 5. Fourth Embodiment

A fourth embodiment is an example of image processing using a target pixel area specified on the basis of the result of object recognition of a subject according to a focusing position in an image to be processed.

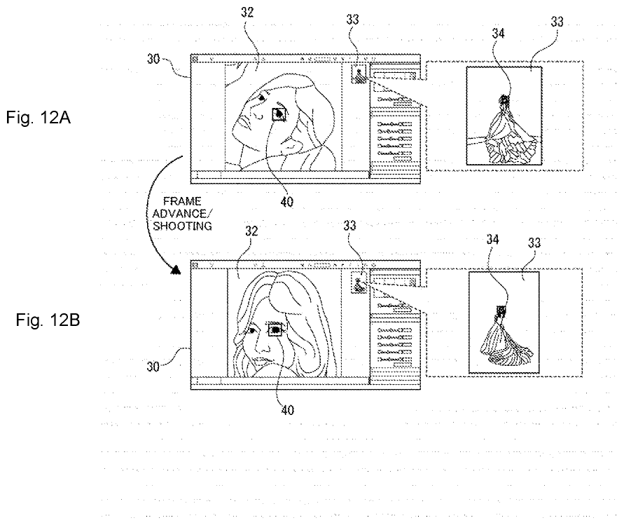

FIG. 12A shows an example in which an enlarged image 32 and an overall image 33 are displayed on a confirmation screen 30.

Also in this case, the enlarged image 32 is not obtained on the basis of a user-specified target subject. The enlarged image 32 is obtained by a CPU 71 that performs object recognition on the basis of a focusing position in an original image and specifies and enlarges a target pixel area including a recognized object.

It is assumed that the original image to be processed obtains focus at an eye of a model serving as a subject. The CPU 71 determines a focusing position in the original image. In this case, the focusing position is the part of the eye of the model.

In this case, the CPU 71 performs object recognition of an area including the focusing position. As a result, for example, a face area is identified. In this case, the CPU 71 sets, as a target pixel area, a pixel area including the part of a face. The target pixel area is then enlarged to display the pixel area as the enlarged image 32 as illustrated in FIG. 12A.

Moreover, the CPU 71 displays the target pixel area based on object recognition such that the target pixel area is indicated by an enlargement frame 34 in the overall image 33. Thus, in particular, regarding an image where an operation for specifying a point of enlargement is not performed, a user can easily recognize the range of an enlarged target pixel area in the overall image 33.

As is evident from a comparison with FIG. 11A, the range of the face is more correctly specified as a target pixel area in FIG. 12A. The enlarged image 32 is obtained by, in particular, cutting and enlarging only the part of the face.

Moreover, the CPU 71 displays a focus frame 40 in the enlarged image 32. The display of the focus frame 40 shows that the enlarged image 32 includes a focus part indicated by the focus frame 40. In this case, the focus frame 40 is not always located at the center of the enlarged image 32. This is because the range of a recognized object (e.g., a face) is set as a target pixel area only on the basis of object recognition.

FIG. 12B illustrates the case where an image to be processed for display is switched. Also in this case, the CPU 71 specifies a target pixel area on the basis of object recognition of a subject including a focusing position and enlarges the area. The enlarged image 32 and the overall image 33 are then displayed on the confirmation screen 30.

As described above, according to the fourth embodiment, the user can view the enlarged image 32, in which the range of a focused subject is accurately enlarged, as one of images to be sequentially confirmed on the confirmation screen 30. It is also effective to provide such display during image confirmation.

The illustrated focus frame 40 obtains focus at the eye. Also in the fourth embodiment, it is needless to say that the focus frame 40 at a face or the focus frame 40 at another article may be displayed. Also in these cases, a target pixel area is specified on the basis of object recognition at a focusing position.

The user may switch between the case where a target pixel area is enlarged and displayed on the basis of a focusing position as in the third embodiment and the case where a target pixel area is enlarged and displayed on the basis of the result of object recognition at a focusing position as in the fourth embodiment. For example, the processing of the fourth embodiment may be suitable for a staff member who confirms a person and an article, and the processing of the third embodiment may be suitable for a staff member who confirms a focusing position. Thus, it is useful for the user to switch the processing as appropriate.

Alternatively, the processing of the third embodiment and fourth embodiment may be automatically selected according to, for example, the type of a subject, an article, and a person.

### 6. Display Examples Applicable to Embodiments

Display examples applicable to the illustrated display of the first to fourth embodiments will be described below.

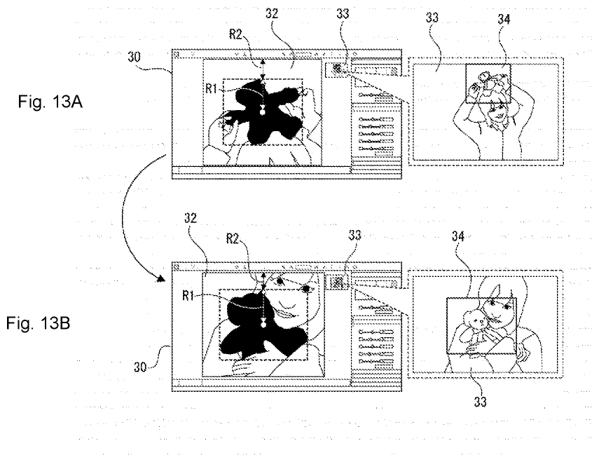

FIGS. 13A and 13B illustrate an example in which the ratio of a subject and a margin is kept regardless of the size of a target subject. As in FIGS. 7A and 7B, a stuffed toy is a target subject.

In FIGS. 13A and 13B, the range of a stuffed toy as a target subject is enlarged and displayed as a target pixel area. As shown in FIGS. 13A and 13B, the ratio of a target subject area R1 and a margin area R2 is kept at a constant ratio in the enlarged image 32. The margin area R2 indicates an area where a target subject is absent.

Specifically, for each image to be processed, an enlargement ratio in the enlargement of a target subject area is varied to keep a constant ratio of the target subject area R1 and the margin area R2.

Thus, it is expected that a target subject can be always displayed in a similar area on the confirmation screen 30 for displaying images, allowing the user to easily check the target subject.

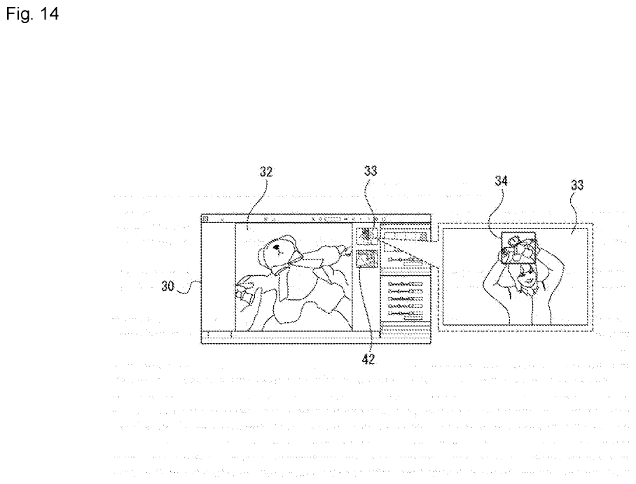

FIG. 14 illustrates an example in which an interface is provided to specify another target subject in addition to a set target subject on the confirmation screen 30.

In FIG. 14, the overall image 33 is displayed along with the enlarged image 32, and the enlargement frame 34 indicating the area of the enlarged image 32 is displayed in the overall image 33.

In this case, a historical image 42 is displayed. This image is assumed to be an image indicating a subject that has been set as a target subject in the past. As a matter of course, a plurality of historical images 42 may be provided.

In response to a user operation for specifying the historical image 42, the setting of a target subject is switched to a setting corresponding to the historical image. Thereafter, a target pixel area is enlarged and displayed on the basis of the switched target subject in each image.

This allows a plurality of staff members to conveniently confirm images from different points to be noticed. For example, it is assumed that a staff member A operates a target subject to confirm a part of an image and then a staff member B specifies another target subject to confirm the image. When the staff member A confirms other images or additionally captured images again, the specification by the staff member A is reflected on the historical image 42. Thus, the staff member A preferably selects the historical image.

The historical image 42 may be a thumbnail image of a target subject (e.g., a face or an article) enlarged in the past or may be an image indicating the enlargement frame 34 (target pixel area) in the overall image at this point.

As another display format, enlargement and display according to a focusing position and enlargement and display according to a target subject may be coexistent with each other. For example, an image enlarged on the basis of a focusing position (or the focus frame 40) is displayed in the left half of the confirmation screen 30 and an enlarged image of an object or the like as a target subject is displayed in the right half of the confirmation screen 30.

Moreover, when a subject, a pose, or a scene is recognized by object recognition or posture estimation, an enlargement ratio or a display format may be changed. For example, whether to keep the enlargement ratio is switched according to the presence or absence of a person, a change of a subject, a change of a pose, or a change of a costume in an image to be processed. For example, when a subject is changed, the enlargement ratio is returned to a default or the enlargement ratio is set at a predetermined value according to the type of the recognized subject. Likewise, whether to display the focus frame 40 may be switched according to the presence or absence of a person, a change of a subject, a change of a pose, or a change of a costume. For example, if a person is absent in an image to be processed, the focus frame 40 is not displayed.

### 7. Processing Example for Display in Embodiments

A processing example for display by the CPU 71 in the embodiments will be described below.

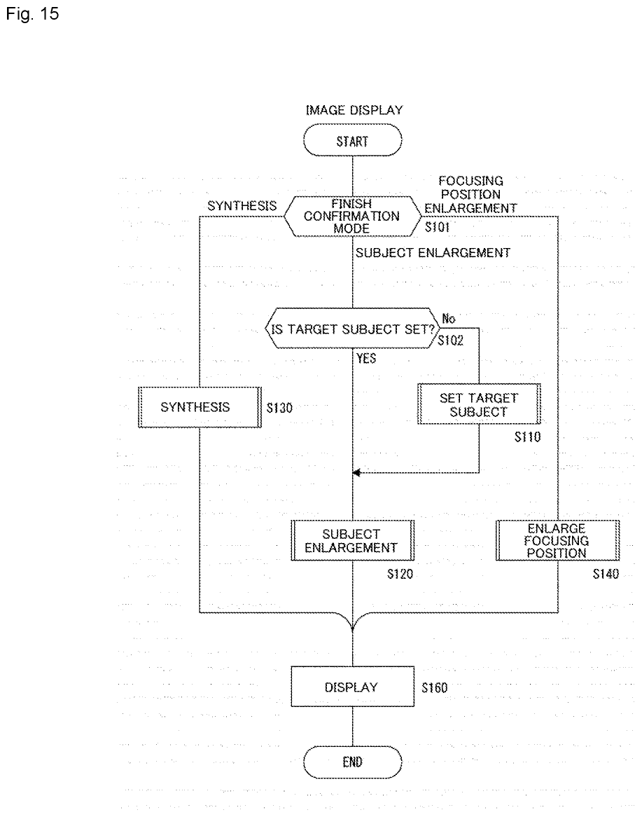

FIG. 15 indicates a processing example of the CPU 71 when an image to be processed is inputted in the process of shooting or frame advance of a reproduced image.

When an image is to be processed, the CPU 71 first causes processing to branch in step S101 in response to a finish confirmation mode.

The finish confirmation mode is a mode about how to confirm a captured image. Specifically, the finish confirmation mode includes “subject enlargement mode” for enlarging a target subject as in the first embodiment, “synthesis mode” for synthesizing a target subject with other images such as the background image 35 as in the second embodiment, and “focusing position enlargement mode” for enlargement using the determination of a focusing position as in the third and fourth embodiments.

For example, these modes are selected by a user operation.

When the subject enlargement mode is selected, the CPU 71 advances from step S101 to S102 to confirm whether a target subject has been set. If a target subject has been set, in other words, a target subject to be processed has been set in an image in the past, the CPU 71 advances to subject enlargement of step S120.

If a target subject has not been set, the CPU 71 sets a target subject in step S110 and then advances to step S120.

In step S120, the CPU 71 enlarges a target pixel area including the target subject as described in the first embodiment.

The CPU 71 then performs control to display the confirmation screen 30 on the display unit 77 in step S160. In this case, as illustrated in FIGS. 5 to 9, processing is performed to display the enlarged image 32 and the overall image 33.

When the synthesis mode is selected, the CPU 71 advances from step S101 to S130 to perform processing described in the second embodiment. Specifically, the processing includes the setting of the background image 35 or the superimposition target frame 38, the setting of a target subject, and synthesis.

The CPU 71 then performs control to display the confirmation screen 30 on the display unit 77 in step S160. In this case, as illustrated in FIG. 10, processing is performed to display the composite image 39 and the overall image 33.

When the focusing position enlargement mode is selected, the CPU 71 advances from step S101 to S140 to perform processing described in the third or fourth embodiment. Specifically, the CPU 71 determines a focusing position, specifies a target pixel area by using the focusing position or object recognition or the like of the focusing position, or makes an enlargement.

The CPU 71 then performs control to display the confirmation screen 30 on the display unit 77 in step S160. In this case, as illustrated in FIG. 11 or 12, processing is performed to display the enlarged image 32 and the overall image 33.

Each step will be specifically described below.

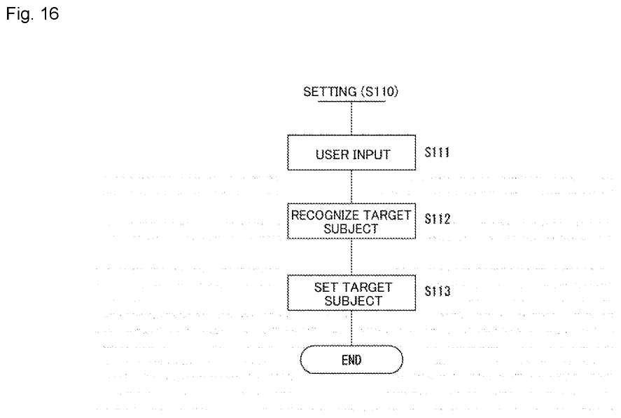

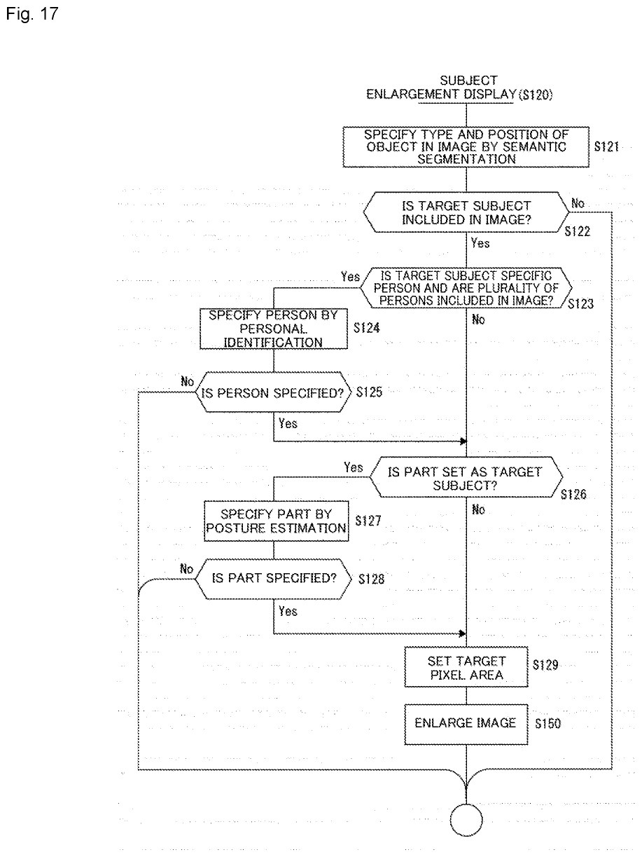

Referring to FIGS. 16 and 17, processing in the subject enlargement mode will be first described in detail.

FIG. 16 is a processing example of the setting of a target subject in step S110 of FIG. 15.

The CPU 71 detects a user input in step S111 of FIG. 16. As described above, the user can perform an operation for specifying a target subject by an operation of a mouse or the like, a voice input, selection of icons or the like, and selection from candidates. In step S111, the CPU 71 detects these inputs.

In step S112, the CPU 71 recognizes a subject specified as a target subject in an image to be currently processed, on the basis of a user input.

In step S113, the CPU 71 sets the subject recognized in step S112, as a target subject to be reflected in the current and subsequent images. For example, the target subject is set according to the type of a person, a human part, and an article, for example, “face,” “person,” “human foot,” “human hand,” “bag,” or “stuffed toy.” Personal identification may be performed to add character information about a specific person to setting information about the target subject.

In a period during which the processing of FIG. 16 is not performed after the start of, for example, tethered shooting (or from the subject enlargement mode), an original image may be displayed as it is in step S160, though the period is not indicated in the flowchart.

Referring to FIG. 17, subject enlargement in step S120 of FIG. 15 will be described below. The target subject has been already set.

In step S121, the CPU 71 specifies the type and position of an object serving as a subject in an image to be currently processed, the object being specified by object recognition using semantic segmentation.

In step S122, the CPU 71 determines the presence or absence of a target subject in an image. In other words, the CPU 71 determines whether a subject corresponding to target subject is recognized as a result of object recognition.

In the absence of a target subject, the CPU 71 terminates the processing of FIG. 17 and advances to step S160 of FIG. 15. In this case, enlargement is not performed and thus the inputted original image is displayed as it is on the confirmation screen 30.

In the presence of a target subject in an image, the CPU 71 advances from step S122 to step S123 to confirm whether the target subject is a specific person and the presence or absence of a plurality of persons in the image.

If the target subject is a specific person and a plurality of persons are present in the image, the CPU 71 advances to step S124 and performs personal identification to determine which one of the persons is the target subject.

If any specific person cannot be specified as the target subject from the plurality of persons in the image, the CPU 71 terminates the processing of FIG. 17 from step S125 and advances to step S160 of FIG. 15. Also in this case, enlargement is not performed and thus the inputted original image is displayed as it is on the confirmation screen 30.

If a specific person can be specified as the target subject from the plurality of persons in the image, the CPU 71 advances from step S125 to step S126.

If the target subject is not a specific person or a plurality of persons are not present in the image, the CPU 71 advances from step S123 to step S126.

In step S126, the CPU 71 causes the processing to branch depending upon whether a specific human part, e.g., a foot or a hand is specified as a target subject.

If a human part is specified as a target subject, the CPU 71 performs posture estimation in step S127 to specify a part of a subject person.

If any part of the subject person cannot be specified, the CPU 71 terminates the processing of FIG. 17 from step S128 and advances to step S160 of FIG. 15. Also in this case, enlargement is not performed and thus the inputted original image is displayed as it is on the confirmation screen 30.

If a part of the subject person can be specified, the CPU 71 advances from step S128 to step S129.

If the target subject is a person or an article, the CPU 71 advances from step S126 to S129. Although “face” is a human part, the processing of step S127 is not necessary if the part of a face can be specified by the processing of object recognition (face recognition) without posture estimation.

In step S129, the CPU 71 specifies a target pixel area on the basis of the position of the target subject in the image. In other words, an area including the determined target subject is specified as a target pixel area.

In step S150, the CPU 71 enlarges the target pixel area.

After the completion of the processing of step S120 in FIG. 17, the CPU 71 advances to step S160 in FIG. 15. In this case, the CPU 71 performs display control to display the enlarged image 32 and the overall image 33 on the confirmation screen 30.

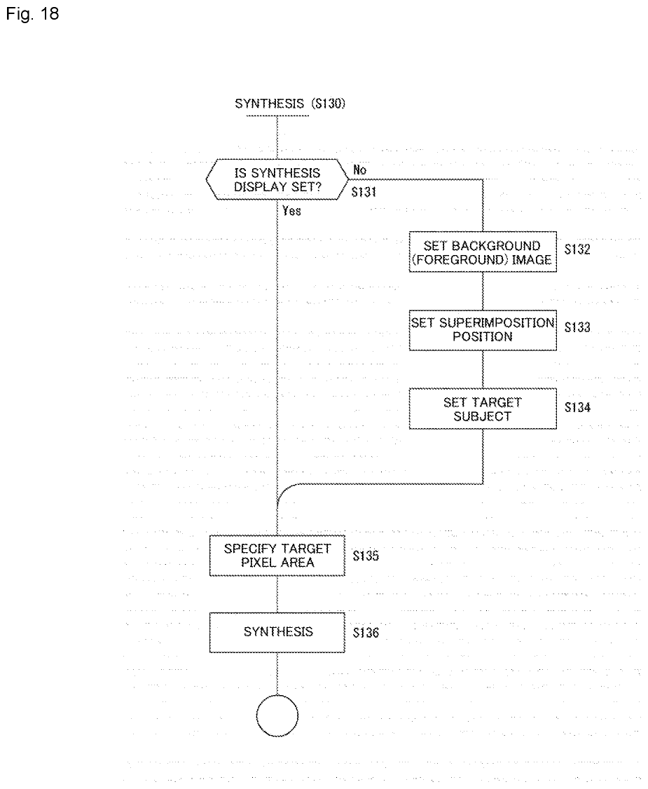

Referring to FIG. 18, the synthesis of step S130 in the synthesis mode will be described below.

In step S131, the CPU 71 confirms whether a setting for synthesis display has been made. In this case, the setting means a setting for the background image 35, a setting for a superimposition position (the range of the superimposition position frame 37), and a setting for a target subject.

If these settings have not been made, the CPU 71 performs the processing of steps S132, S133, and S134.

Specifically, the CPU 71 selects a background image in step S132. For example, a certain image is selected as a background image in response to a user operation for specifying an image. A foreground image may be set instead.

In step S133, the CPU 71 sets a superimposition position in the background image 35. For example, a specific range on the background image 35 is set as a superimposition position in response to a user operation for specifying a range.

When the setting is made, the superimposition position frame 37 is displayed such that the user can recognize the superimposition position while performing an operation for specifying the range.

In step S134, the CPU 71 sets a target subject in an image to be currently processed. In other words, the CPU 71 recognizes a user input to an image to be processed and specifies a target subject. Specifically, in step S134, the CPU 71 may perform the same processing as FIG. 16.

In a period during which the processing of steps S132, S133, and S134 is not performed after the start of, for example, tethered shooting (or from the synthesis mode), an original image may be displayed as it is in step S160, though the period is not indicated in the flowchart.

In a state where the foregoing settings are made, the CPU 71 sets a target pixel area in step S135 of FIG. 18 and performs synthesis in step S136.

Specifically, in step S135, the CPU 71 specifies a target subject in an image to be currently processed and specifies a target pixel area including the target subject.

In step S136, the CPU 71 makes an enlargement or reduction to adjust the size of the target pixel area and the size of the superimposition position in the background image 35 and synthesizes the image of the target pixel area onto the background image 35.

After the completion of the processing of FIG. 18, the CPU 71 advances to step S160 in FIG. 15. In this case, the CPU 71 performs display control to display the composite image 39 and the overall image 33 on the confirmation screen 30.

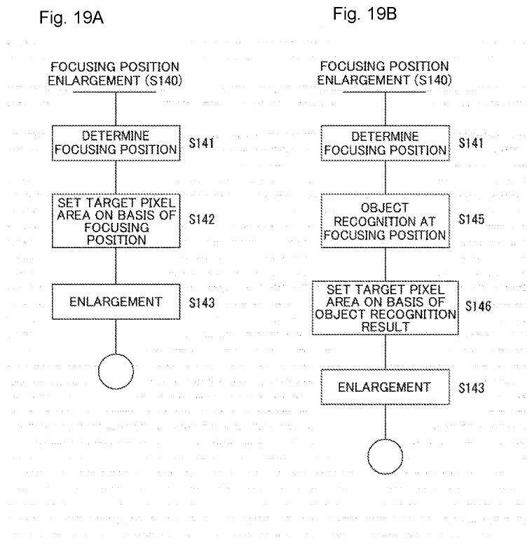

Referring to FIGS. 19A and 19B, the synthesis of step S140 in the focusing position enlargement mode will be described below. FIG. 19A shows that the processing of the third embodiment is adopted as the focusing position enlargement mode, and FIG. 19B shows that the processing of the fourth embodiment is adopted as the focusing position enlargement mode.

First, in step S141 of the processing example of FIG. 19A, the CPU 71 determines a focusing position in an image to be currently processed. The focusing position may be determined on the basis of metadata or image analysis.

In step S142, the CPU 71 sets an area to be enlarged on the basis of the focusing position, that is, a target pixel area. For example, a predetermined pixel range with respect to the focusing position is set as a target pixel area.

In step S143, the CPU 71 enlarges the target pixel area.

After the completion of the processing of step S140 in FIG. 19A, the CPU 71 advances to step S160 in FIG. 15. In this case, the CPU 71 performs display control to display the enlarged image 32 and the overall image 33 on the confirmation screen 30.

In the processing example of FIG. 19B, in step S141, the CPU 71 determines a focusing position in an image to be currently processed.

Subsequently, in step S145, a subject at the focusing position is recognized by object recognition. For example, “face” or “bag” is recognized. The subject to be specified is focused by a photographer during shooting.

In step S146, the CPU 71 sets an area to be enlarged on the basis of the recognized subject, that is, a target pixel area. For example, if “face” is recognized as a subject including a focusing position, a pixel range including the range of a face is set as a target pixel area.

In step S143, the CPU 71 enlarges the target pixel area.

After the completion of the processing of step S140 in FIG. 19B, the CPU 71 advances to step S160 in FIG. 15. In this case, the CPU 71 performs display control to display the enlarged image 32 and the overall image 33 on the confirmation screen 30. The enlarged image 32 is obtained by enlarging the range of a recognized object.

### 8. Conclusion and Modification Example

According to the foregoing embodiments, the following effects are obtained.

The information processing device 70 according to the embodiments has the function (the function of FIG. 3) of performing processing for the display of an inputted image and corresponds to “image processing device” in the following description.

The image processing device (information processing device 70) for performing the processing described in the first, second, third, and fourth embodiments includes an image processing unit 51 that specifies a target pixel area including a target subject from an image to be processed and performs image processing using the specified target pixel area.

Thus, an image is displayed using the pixel area of the target subject. For example, an image suitable for confirming an image of the target subject can be automatically displayed.

In the example of the image processing device (information processing device 70) according to the first and second embodiments, a target subject set on a first image by the image processing unit 51 is determined by image analysis on a second image to be processed, and image processing performed on the second image by using a target pixel area specified on the basis of the determination of the target subject. In other words, after a target subject is set in a certain image (first image), other images (second image) are set to be processed. At this point, in the second image, a target subject is determined by image analysis and a target pixel area is specified. Since the target subject is set in the first image, image processing can be performed on the basis of the determination of the target subject in the second image to be subsequently processed, without the need for, for example, a user operation for setting the target subject. The image processed thus can be an image suitable for image display in which a specific subject is to be confirmed sequentially in a plurality of images.

This can achieve quite efficient image confirmation in use cases such as tethered shooting, thereby improving the efficiency of commercial photography and the quality of captured images.

In the image processing device (the information processing device 70) according to the first and second embodiments, object recognition is performed as image analysis. For example, a person, a face, or an article or the like set as a target subject on the first image by semantic segmentation is determined on the second image. Thus, in each inputted image, a person, a human part (face, hand, foot), or an article or the like can be automatically set as a target pixel area to be enlarged or synthesized.

In the example of the image processing device (the information processing device 70) according to the first embodiment, personal identification is performed as image analysis.

A specific person is identified by personal identification, so that the pixel area of the specific person can be automatically set as a target pixel area to be enlarged or synthesized.

In the second embodiment, a specific person may be set as a target subject and subjected to personal identification. Thus, even if a plurality of persons are included in an image to be processed, the specific person can be synthesized onto a background image.

In the example of the image processing device (the information processing device 70) according to the first embodiment, posture estimation is performed as image analysis.

For example, if a target subject is a hand of a model, a foot, an article held with a hand, or a shoe of the model, the pixel area can be specified by the posture of the model. Thus, a part to be noticed can be properly set as a target pixel area to be enlarged or synthesized.

This may be applied to the second embodiment. Specifically, posture estimation may be performed when a target subject, e.g., a body part is determined. Thus, a specific part in an image to be processed can be recognized according to posture estimation and synthesized onto a background image.

In the example of the first embodiment, image processing is enlargement of an image of a target pixel area.

Processing is performed to enlarge a target pixel area, so that an enlarged image of a target subject can be displayed for a plurality of images. This can provide quite a convenient function when a target subject is to be confirmed sequentially in a plurality of images.

In the example of the second embodiment, image processing is synthesis of an image of a target pixel area onto other images.

Synthesis is performed using a target pixel area, thereby generating a composite image such that, for example, a plurality of images including a target subject can be sequentially synthesized onto, for example, a specific background image and confirmed. This can provide quite a convenient function when states of image synthesis using a target subject are to be sequentially confirmed.

The synthesis includes processing of enlarging a target pixel area to be synthesized onto a background image or reducing a target pixel area to be synthesized onto a background image as well as processing of simply synthesizing a target pixel area onto a background image. An image to be synthesized is not limited to a background image. An image to be synthesized may be a foreground image or a target pixel area may be synthesized onto both of a background image and a foreground image.

In the first and second embodiments, it is assumed that the second image (other images to be processed after a target subject is set) indicates a plurality of images inputted to be processed after the first image (an image where a target subject is set).

After a target subject is set in the first image, for example, if captured images are inputted by sequential shooting or images are sequentially inputted by frame advance of reproduced images, the sequentially inputted images are subjected to image analysis as second images.

Thus, in a plurality of images sequentially inputted after the target subject is set in the first image, image processing is performed to automatically enlarge or synthesize the pixel area of the target subject without specifying the target subject. Therefore, when a target subject is to be confirmed in the process of shooting or when a target subject is to be confirmed during frame advance of reproduced images, a large number of images are confirmed with great convenience.

In the example of the first and second embodiments, the setting unit 52 is provided to set a target subject on the basis of a specification input on the first image.

For example, a user specifies a target subject in the first image, so that the setting of the target subject is reflected in subsequent images before the images are enlarged or synthesized. The user can freely specify, for example, a person, a face, a hand, hair, a foot, or an article as a subject to be noticed for confirmation of an image, and an enlarged image or a composite image is provided in response to the needs of the user. This offers convenience in conformation of tethered shooting. If subjects to be noticed particularly vary among staff members, the subjects can be easily handled.

In the example of the first and second embodiments, a specification input of a target subject can be a voice specification input.

The specification input may be performed by an operation of specifying a range in an image or, for example, a voice input. For example, when the user utters “face,” “face” is recognized as a target subject by image analysis and then a target pixel area is set. This facilitates a specification input by the user.

In the third embodiment, the CPU 71 (image processing unit 51) performs image processing using a target pixel area that is specified on the basis of a focusing position in an image to be processed.

Thus, a target pixel area can be set on the basis of a focused subject, and image processing can be performed on the basis of the target pixel area. The image processed thus can be an image suitable for image display in which a focused subject is to be confirmed sequentially in a plurality of images. The user does not need to specify a target subject.

In the third embodiment, image processing is enlargement of an image of a target pixel area on the basis of a focusing position.

Thus, an enlarged image can be displayed with respect to the focusing position, thereby providing quite a convenient function when a focused subject is to be confirmed sequentially in a plurality of images.

In the fourth embodiment, the CPU 71 (image processing unit 51) performs image processing using a target pixel area specified on the basis of the result of object recognition of a subject according to a focusing position in an image to be processed. Thus, the target pixel area is specified on the basis of object recognition of the subject according to the focusing position. This specifies the range of the subject at the focusing position. Thus, image processing is performed on a focused subject by image processing based on the target pixel area. The image processed thus can be an image suitable for image display in which a focused subject is to be confirmed sequentially in a plurality of images.

In this case, the user does not need to specify a target subject.

In the fourth embodiment, image processing is enlargement of an image of a target pixel area on the basis of object recognition of a subject according to a focusing position.

Thus, for example, the result of object recognition according to a focusing position does not always need to be obtained with respect to the focusing position. An enlarged image can be displayed in the range of a recognized object, e.g., a face, a body, or an article or the like. Consequently, a more convenient function can be provided when a focused subject is to be confirmed sequentially in a plurality of images.

As a display example applicable to the embodiments, the image processing unit 51 determines a change of a target subject or a change of a scene by image analysis and changes the contents of image processing according to the determination of the change.

For example, in the process of sequentially inputting images, when the pose or costume of a target subject is changed, a person is changed, or a change of a scene is detected by a change of a person or a background, the contents of image processing are changed. Specifically, an enlargement ratio of enlargement is changed or the focus frame 40 is switched to a displayed state or a hidden state. This can properly set a display format according to the contents of an image.

In the first, second, third, and fourth embodiments, the image processing device (information processing device 70) includes the display control unit 50 that performs control to display an image (enlarged image 32 or composite image 39) subjected to image processing by the image processing unit 51 and the overall image 33 including a target pixel area to be subjected to image processing.

Thus, the user can confirm the enlarged image 32 and the composite image 39 while confirming the overall image 33, and an interface with high usability can be provided.

In the first, third, and fourth embodiments, the enlarged image 32 may be displayed on the confirmation screen 30 without the overall image 33.

Likewise, in the second embodiment, the composite image 39 may be displayed without the overall image 33.

In the example of the first, second, third, and fourth embodiments, for example, frame display (the enlargement frame 34, the superimposition target frame 38) is provided in the overall image 33 as the display of a target pixel area to be subjected to image processing.

Thus, the user can easily recognize an enlarged part or a synthesized part of the overall image 33.

The display of a target pixel area is not limited to a frame display format. The color of the corresponding part may be changed, the luminance may be changed, or the corresponding part may highlighted.

In the processing example of FIG. 15, the processing of the subject enlargement mode, the synthesis enlargement mode, and the focusing position enlargement mode is selectively performed. It is also assumed that the information processing device 70 performs processing in only one of the modes. Alternatively, it is assumed that the information processing device 70 selectively performs processing in two of the modes.

In the embodiments, the confirmation screen 30 is displayed in the information processing device 70. The technique of the present disclosure is also applicable to the imaging device 1. For example, in the imaging device 1, the camera control unit 18 may have the function of FIG. 3 to perform the processing of the embodiments such that the confirmation screen 30 is displayed on, for example, the display unit 15 as described in the embodiments. Hence, the imaging device 1 can act as an image processing device of the present disclosure.

Moreover, processing described in the embodiments may be applied to moving images.

If the CPU 71 or the like has a high throughput, a target subject specified for a certain frame of moving images can be determined by image analysis for each of subsequent frames, a target pixel area can be set, and an enlarged image or a composite image of the target pixel area can be displayed.

Thus, during video shooting or video replay, an enlarged image of the target subject can be viewed with an overall image.

A program according to the embodiments is a program that causes, for example, a CPU, a DSP, a GPU, a GPGPU, and an AI processor or the like or a device including the units and processors to perform the processing of FIGS. 15 to 19.

In other words, the program according to the embodiments specifies a target pixel area including a target subject from an image to be processed and causes the information processing device to perform image processing using the specified target pixel area.

Such a program can implement the image processing device of the present disclosure with various computer devices.

These programs can be recorded in advance in an HDD serving as a recording medium embedded in devices such as a computer device or a ROM or the like in a microcomputer that includes a CPU.

Alternatively, the program can be stored (recorded) temporarily or perpetually on a removable recording medium such as a flexible disc, a CD-ROM (Compact Disc Read Only Memory), a MO (Magneto Optical) disc, a DVD (Digital Versatile Disc), a Blu-ray Disc (registered trademark), a magnetic disk, a semiconductor memory, or a memory card. Such a removable recording medium can be provided as so-called package software.

Such a program can be installed from a removable recording medium to a personal computer or the like and can also be downloaded from a download site via networks such as a LAN (Local Area Network) and the Internet.

Furthermore, such a program is suitable for widely providing the image processing device of the present disclosure. For example, by downloading the program to portable terminal devices such as a smartphone and a tablet, a mobile phone, a personal computer, a game device, a video device, and a PDA (Personal Digital Assistant), these devices can be caused to function as the image processing device of the present disclosure.

Note that the advantageous effects described in the present specification are merely exemplary and are not limited, and other advantageous effects may be obtained.

Note that the present technique can also adopt the following configurations.

(1)

An image processing device includes an image processing unit that specifies a target pixel area including a target subject from an image to be processed and performs image processing using the specified target pixel area.

(2)

The image processing device according to (1),
wherein the image processing unit determines a target subject set on a first image, the target subject being determined by image analysis on a second image to be processed, and the image processing unit performs image processing on the second image by using a target pixel area specified on the basis of the determination of the target subject.
   (3)

The image processing device according to (2), wherein the image analysis is object recognition.

(4)

The image processing device according to (2) or (3), wherein the image analysis is personal identification.

(5)

The image processing device according to any one of (2) to (4), wherein the image analysis is posture estimation.

(6)

The image processing device according to any one of (1) to (5), wherein the image processing is enlargement of an image of a target pixel area.

(7)

The image processing device according to any one of (1) to (5), wherein the image processing is synthesis of an image of a target pixel area onto other images.

(8)

The image processing device according to any one of (2) to (7), wherein the second image indicates a plurality of images inputted to be processed after the first image.

(9)

The image processing device according to any one of (2) to (8), further including a setting unit that sets a target subject on the basis of a specification input on the first image.

(10)

The image processing device according to (9), wherein the specification input is allowed to be a voice specification input.

(11)

The image processing device according to (1),
wherein the image processing unit performs image processing using a target pixel area specified on the basis of a focusing position in an image to be processed.
   (12)

The image processing device according to (11), wherein the image processing is enlargement of an image of the target pixel area on the basis of the focusing position.

(13)

The image processing device according to (1),
wherein the image processing unit performs image processing using a target pixel range specified on a basis of a result of object recognition of a subject according to a focusing position in the image to be processed.
   (14)

The image processing device according to (13), wherein the image processing is enlargement of an image of the target pixel area on the basis of object recognition of the subject according to the focusing position.

(15)

The image processing device according to any one of (1) to (14),
wherein the image processing unit determines a change of a target subject or a change of a scene by image analysis and changes the contents of image processing according to the determination of the change.
   (16)

The image processing device according to any one of (1) to (15), further including a display control unit that performs control to display an image having been subjected to image processing by the image processing unit along with an overall image including a target pixel area to be subjected to image processing.

(17)

The image processing device according to (16), wherein, in the overall image, display is provided to indicate a target pixel area to be subjected to image processing.

(18)

An image processing method including:
causing an image processing device to specify a target pixel area including a target subject from an image to be processed and perform image processing using the specified target pixel area.
   (19)

A program that causes an image processing device to specify a target pixel area including a target subject from an image to be processed and perform image processing using the specified target pixel area.

### REFERENCE SIGNS LIST

1 Imaging device
3 Transmission line
18 Camera control unit
30 Confirmation screen
31 Original image
32 Enlarged image
33 Overall image
34 Enlargement frame
35 Background image
36 Original image
37 Superimposition position frame
38 Superimposition target frame
39 Composite image
40 Focus frame
41 Specific person
42 Historical image
50 Display control unit
51 Image processing unit
52 Setting unit
53 Object recognition unit
54 Personal identification unit
55 Posture estimation unit
56 Focusing position determination unit
70 Information processing device
71 CPU

1. An image processing device comprising an image processing unit that specifies a target pixel area including a target subject from an image to be processed and performs image processing using the specified target pixel area.

2. The image processing device according to claim 1,
wherein the image processing unit determines a target subject set on a first image, the target subject being determined by image analysis on a second image to be processed, and the image processing unit performs image processing on the second image by using a target pixel area specified on a basis of the determination of the target subject.

3. The image processing device according to claim 2, wherein the image analysis is object recognition.

4. The image processing device according to claim 2, wherein the image analysis is personal identification.

5. The image processing device according to claim 2, wherein the image analysis is posture estimation.

6. The image processing device according to claim 1, wherein the image processing is enlargement of an image of a target pixel area.

7. The image processing device according to claim 1, wherein the image processing is synthesis of an image of a target pixel area onto other images.

8. The image processing device according to claim 2, wherein the second image indicates a plurality of images inputted to be processed after the first image.

9. The image processing device according to claim 2, further comprising a setting unit that sets a target subject on a basis of a specification input on the first image.

10. The image processing device according to claim 9, wherein the specification input is allowed to be a voice specification input.

11. The image processing device according to claim 1,
wherein the image processing unit performs image processing using a target pixel area specified on a basis of a focusing position in an image to be processed.

12. The image processing device according to claim 11, wherein the image processing is enlargement of an image of the target pixel area on the basis of the focusing position.

13. The image processing device according to claim 1,
wherein the image processing unit performs image processing using a target pixel range specified on a basis of a result of object recognition of a subject according to a focusing position in the image to be processed.

14. The image processing device according to claim 13, wherein the image processing is enlargement of an image of the target pixel area on the basis of object recognition of the subject according to the focusing position.

15. The image processing device according to claim 1,
wherein the image processing unit determines a change of a target subject or a change of a scene by image analysis and changes contents of image processing according to the determination of the change.

16. The image processing device according to claim 1, further comprising a display control unit that performs control to display an image having been subjected to image processing by the image processing unit along with an overall image including a target pixel area to be subjected to image processing.

17. The image processing device according to claim 16, wherein, in the overall image, display is provided to indicate a target pixel area to be subjected to image processing.

18. An image processing method comprising:
causing an image processing device to specify a target pixel area including a target subject from an image to be processed and perform image processing using the specified target pixel area.

19. A program that causes an image processing device to specify a target pixel area including a target subject from an image to be processed and perform image processing using the specified target pixel area.
